(19) United States
(12) Patent Application Publication
(10) Pub. No.: US 2026/0363280 A1
(43) Pub. Date: Nov. 19, 2026

(54) EDIBLE INK COMPOSITIONS AND RELATED PRODUCTS AND METHODS

(71) Applicant: Wm. Wrigley Jr. Company, Chicago, IL (US)

(72) Inventors: Francisco J. CORIA, Chicago, IL (US); Joseph KRUPA, JR., Chicago, IL (US); Penny Frances MARTIN, Chicago, IL (US); Xiaoqun MO, Chicago, IL (US); Paul Marijan SRNAK, Chicago, IL (US); Michael Douglas WIDRICK, Chicago, IL (US)

(21) Appl. No.: 19/109,838

(22) PCT Filed: Sep. 7, 2023
(86) PCT No.: PCT/US2023/073651

§ 371 Date: Mar. 7, 2025

Related U.S. Application Data
(60) Provisional application No. 63/404,651, filed on Sep. 8, 2022.

(51) Int. Cl. A23L 5/42; A23G 3/34

(52) U.S. Cl. CPC A23L 5/42; A23G 3/343

(57) ABSTRACT

Edible ink compositions and methods of preparation and uses thereof are described. The edible ink composition may include a pigment having at least 26% by weight calcium carbonate, based on the total weight of the composition, at least one binder, and at least one solvent. The composition may be edible and may be formulated for printing on a substrate.

### CROSS-REFERENCE TO RELATED APPLICATIONS

This application claims priority to U.S. Provisional Application No. 63/404,651, filed on Sep. 8, 2022, which is incorporated by reference herein in its entirety.

### TECHNICAL FIELD

The present disclosure generally relates to edible ink compositions, including compositions comprising calcium carbonate that exhibit improved binding properties. The compositions may be suitable for edible substrates to provide improved quality and stability.

### BACKGROUND

Various white pigments derived from natural ingredients are useful in edible ink formulations for food products. For instance, calcium carbonate has been used as a white pigment in edible ink formulations in place of titanium dioxide. However, higher amounts of calcium carbonate often present challenges, including an undesirably high viscosity that complicates printing onto substrates. Edible ink compositions can also quickly rub off upon contact or fade in appearance over time.

### SUMMARY

The present disclosure includes edible ink compositions, products containing the edible ink compositions, and methods of making the compositions and products. For example, the present disclosure includes an edible ink composition comprising a pigment comprising at least 26% by weight calcium carbonate, based on the total weight of the composition; at least one binder; and at least one solvent; wherein the composition is edible and formulated for printing on a substrate. The calcium carbonate may comprise scalenohedral calcium carbonate. In some examples, the composition may comprise from 27% by weight to about 37% by weight, or from about 30% by weight to about 32% by weight, of the calcium carbonate. Additionally or alternatively, the composition may comprise from about 5% by weight to about 35% by weight, based on the total weight of the composition, of the at least one binder and/or from about 30% by weight to about 75% by weight, based on the total weight of the composition, of the at least one solvent. In some examples, the at least one binder may comprise shellac, ethyl cellulose, carboxymethylcellulose (CMC), hydroxypropylmethylcellulose (HPMC), hydroxypropylcellulose (HPC), zein, rosin, a rosin ester, xanthan gum or a combination thereof.

According to some aspects of the present disclosure, the at least one binder may comprise esterified shellac. In some examples, the at least one solvent may comprise ethanol, optionally denatured ethanol. The composition may further comprise at least one emulsifier. For example, the at least one emulsifier may comprise lecithin, a polysorbate, a polyglycerol ester, a monoglyceride ester, a diglyceride ester, or a combination thereof. In some examples, the composition may comprise from about 0.25% to about 4% by weight, based on the total weight of the composition, of an emulsifier.

The edible ink composition may further comprise an oil absorber. For example, the oil absorber may comprise a natural starch, a modified starch, acacia gum, sodium caseinate, microcrystalline cellulose, maltodextrin, carboxymethylcellulose, cocoa, or a combination thereof. In some examples, the composition may further comprise rice protein, rice starch, tricalcium phosphate, spirulina, cocoa powder, another edible colorant, or a combination thereof.

In at least one example, the calcium carbonate may comprise scalenohedral calcium carbonate and limestone. In some examples, at least a portion of the calcium carbonate may be encapsulated. In at least one example, the calcium carbonate may comprise scalenohedral calcium carbonate and encapsulated calcium carbonate. According to some aspects of the present disclosure, the composition may have a Brookfield viscosity ranging from about 30 cP to less than or equal to 20,000 cP at 25 °C. The at least one solvent may comprise an alcohol, water, or a combination thereof. In some examples, the composition does not comprise isoamyl alcohol, does not comprise titanium dioxide, or does not comprise isoamyl alcohol or titanium dioxide.

The present disclosure also includes an edible product comprising a composition as described above and/or elsewhere herein on a surface of the product, optionally with a clear or translucent layer over the surface. In at least one example, the surface may be an outermost surface of the product. The product may be a confectionery product. In some examples, the product may comprise a waxy coating and the composition may be printed onto the coating.

The present disclosure also includes a method of making the products described above and elsewhere herein, wherein the method comprises printing the composition on the surface of the product. In some examples, the composition may be printed as a logo or lettering on a region of the surface of the product.

### DETAILED DESCRIPTION

Particular aspects of the present disclosure are described in greater detail below. The terms and definitions provided herein control, if in conflict with terms and/or definitions incorporated by reference.

As used herein, the terms “comprises,” “comprising,” or any other variation thereof are intended to cover a non-exclusive inclusion, such that a process, method, composition, article, or apparatus that comprises a list of elements does not include only those elements, but may include other elements not expressly listed or inherent to such process, method, composition, article, or apparatus. The term “exemplary” is used in the sense of “example” rather than “ideal.” As used herein, the singular forms “a,” “an,” and “the” include plural reference unless the context dictates otherwise. Relative terms such as “about,” “substantially,” and “approximately” refer to being nearly the same as a referenced number or value, and should be understood to encompass a variation of ±5% of a specified amount or value.

Exemplary compositions according to the present disclosure may comprise at least 26% by weight of at least one pigment, based on the total weight of the composition, at least one binder, and at least one solvent. The compositions herein may further comprise at least one of an emulsifier, oil absorber, or combination thereof, and/or one or more other components (e.g., salts, fatty acids, pH modifiers, preservatives, natural or artificial flavor compounds, plasticizers, dispersants, fillers, and/or micronutrients). The pigment(s) may comprise calcium carbonate and/or may be devoid of titanium dioxide. The compositions herein may provide for increased adhesion to a substrate, and may allow for a relatively high amount of pigment to achieve a desired color and/or intensity of color. The compositions herein may be edible and in the form of an ink suitable for printing or otherwise transferring to the surface of an edible product.

The compositions herein comprise at least one pigment, which may be natural or artificial. For example, the pigment may comprise calcium carbonate to provide a white appearance. The compositions herein may allow for higher amounts of calcium carbonate while maintaining a desired viscosity useful for transferring and drying on a substrate. In some examples, the composition may comprise 30 wt. % or greater calcium carbonate.

In some examples of the present disclosure, the composition comprises calcium carbonate particles having a particle size ranging from about 0.5 μm to about 15 μm, such as from about 0.5 μm to about 8 μm, from about 0.5 μm to about 5 μm, from about 0.5 μm to about 3 μm, from about 1 μm to about 3 μm, from about 1.5 μm to about 3 μm. Particle size refers to the d₅₀ value, which is the particle diameter at which 50% by weight of the particles have a smaller diameter.

The calcium carbonate may be in one or more different forms. The calcium carbonate particles may be in the form of calcite (e.g., scalenohedral calcium carbonate), limestone, or mixtures thereof. Scalenohedral calcium carbonate may provide desirable reflectance and light scattering properties. A commercial scalenohedral calcium carbonate suitable for the present disclosure is ViCALity™ (Minerals Technologies, Inc.). Precipitated calcium carbonate, in calcite form, having a crystalline structure that is different from a scalenohedral structure, such as rhombohedral, hexagonal prismatic, pinacoidal, colloidal, cubic, or prismatic, may be used in addition to, or as an alternative to, scalenohedral calcium carbonate. Without being bound by theory, it is believed that the presence of scalenohedral calcium carbonate particles may provide for longer term stability in addition to desired color properties of the composition. In some examples, the composition may comprise scalenohedral calcium carbonate particles and ground limestone, e.g., in a weight ratio (scalenohedral calcium carbonate:limestone) of 10:1 to about 1:1, such as about 8:1, about 5:1, or about 3:1.

In some examples, at least a portion of the calcium carbonate present in the composition may be in an encapsulated or co-dried form. For example, some or all of the calcium carbonate may be combined with another material, such as an encapsulating agent or a co-drying agent, using encapsulation or co-drying techniques to increase oil resistance. Any one of calcite (e.g., scalenohedral calcium carbonate), limestone, or mixtures thereof may be encapsulated or co-dried. Suitable materials for encapsulation or co-drying according to the present disclosure may include, but are not limited to, polymers and copolymers (e.g., polyvinyl acetate (PVAC)), natural gums (e.g., gum arabic, locust bean gum, xanthan gum, and carrageenan), cellulose, cellulose derivatives (e.g., ethyl cellulose, methyl cellulose, sodium hydroxymethylcellulose, carboxymethylcellulose (CMC) including sodium carboxymethylcellulose (NaCMC), hydroxypropylcellulose (HPC), and hydroxypropylmethyl cellulose (HPMC)), and mixtures thereof. Encapsulation and/or co-drying techniques, which may be used herein to obtain encapsulated or co-dried calcium carbonate include, but are not limited to, spray drying, fluid bed drying, spray chilling, coacervation, granulation, extrusion, freeze drying, prilling, adsorption, and agglomeration. In at least one example, calcium carbonate particles may be encapsulated with PVAC using extrusion. In other examples, calcium carbonate may be dried with cellulosic material or materials such as HPMC, HPC, CMC such as NaCMC, gum arabic, maltodextrin, or modified starch (e.g., starch sodium octenyl succinate) and ground to a desired particle size, such as a particle size ranging from about 0.5 μm to about 15 μm.

The compositions herein, e.g., edible ink compositions, may comprise scalenohedral calcium carbonate particles and encapsulated calcium carbonate, e.g., in a weight ratio (scalenohedral calcium carbonate:encapsulated or co-dried calcium carbonate) of about 10:1 to about 1:1, such as about 9:1, about 5:1, or about 2:1. Without being bound by theory, it is believed that the presence of a protected calcium carbonate, e.g., encapsulated calcium carbonate or co-dried calcium carbonate, in combination with scalenohedral calcium carbonate particles may provide for increased resistance to fading and may maintain at least some of the color properties provided by calcium carbonate even if the scalenohedral calcium carbonate particles fade due to oil absorption.

In some aspects of the present disclosure, the composition, e.g., edible ink composition, may comprise greater than or equal to about 25 wt. % or greater than or equal to about 30 wt. % calcium carbonate, based on the total weight of the composition. For example, the composition may comprise from about 25 wt. % to about 40 wt. % or from about 25 wt. % to about 37 wt. % calcium carbonate, based on the total weight of the composition. In some aspects, the composition may comprise about 27 wt. % to about 37 wt. %, from about 28 wt. % to about 36 wt. %, from about 30 wt. % to about 35 wt. %, or from about 32 wt. % to about 34 wt. % calcium carbonate, based on the total weight of the composition. In at least one example, the composition comprises about 32 wt. % scalenohedral calcium carbonate. In some examples, the edible ink composition comprises from about 26 wt. % to about 28 wt. % scalenohedral calcium carbonate. In at least one example, the composition comprises about 30 wt. % scalenohedral calcium carbonate.

In some examples herein, the edible ink composition may comprise calcium carbonate and one or more additional pigments. For example, the composition may comprise calcium carbonate in combination with another white pigment and/or a non-white pigment. The composition may comprise calcium carbonate in combination with any pigment (e.g., an edible colorant) or mixture of pigments to form an ink composition with a desired shade. For example, the composition may comprise a calcium carbonate in combination with a black, brown, grey pigment, or colorant system (comprising, e.g., FD&C colorant(s) such as FD&C dyes and FD&C lakes) to form an ink composition with a generally gray appearance. Exemplary pigments other than calcium carbonate that may be used in the compositions herein include, but are not limited to, riboflavin (vitamin B2), rice protein, tricalcium phosphate (TCP), rice starch, spirulina, and cocoa powder. In some examples, mica-based metallic pearlescent pigments may be used in compositions comprising calcium carbonate. An exemplary mica-based metallic pearlescent pigment may be in the form of mica plated or fused with titanium dioxide as a compound. In some examples, the calcium carbonate in the composition may include both free calcium carbonate particles and encapsulated or co-dried calcium carbonate. The compositions herein may comprise at least 27 wt. % calcium carbonate and about 1 wt. % to about 8 wt. % one or more additional pigments, such as from about 2 wt. % to about 7 wt. % one or more pigments other than calcium carbonate.

In some examples, the composition may comprise rice protein, rice starch, and/or TCP in combination with calcium carbonate. Without being bound by theory, it is believed that TCP may increase the stability of the edible ink composition. The present disclosure also envisions rice protein, rice starch, and/or TCP as pigments having a generally white appearance as an alternative to the calcium carbonate. In at least one example, the composition comprises at least 27 wt. % TCP, such as about 27 wt. % to about 37 wt. % TCP, wherein the composition does not comprise calcium carbonate and/or titanium dioxide.

In at least one example, the composition may comprise spirulina in combination with calcium carbonate. Without being bound by theory, it is believed that spirulina in the edible ink composition may provide a synergistic effect. For example, spirulina may help reduce and/or break surface tension, may help to flatten or smooth out edible ink compositions for printing on a surface of a substrate, and/or may aid in preventing edible ink compositions from balling or beading up on the surface of a substrate. In at least one example, the composition comprises calcium carbonate and greater than 0 to less than 8 wt. % spirulina, such as, e.g., greater than 0 to less than 5 wt. % spirulina or greater than 0 to less than 3 wt. % spirulina.

The compositions herein also may comprise one or more solvents. Exemplary solvents suitable for the present disclosure include, but are not limited to, alcohols (e.g., C2 to C6 alcohols, diols, etc.), water (including, e.g., aqueous solutions), and combinations thereof. The alcohols may include, but are not limited to, isopropanol, 1-propanol, ethanol, 1-butanol, 3-methyl-1-butanol (isoamyl alcohol), 2-butanol, hexanol, propylene glycol (PG), polyethylene glycol (PEG), and glycerol. In some examples, the alcohol may be denatured. For example, the composition may comprise denatured ethanol, e.g., ethanol has been combined with a denaturant, such as ethyl acetate. In aspects of the present disclosure, the composition may comprise from about 30 wt. % to about 75 wt. %, from about 40 wt. % to about 70 wt. %, from about 50 wt. % to about 65 wt. %, or from about 60 wt. % to about 70 wt. % solvent(s), based on the total weight of the composition.

The compositions herein may comprise one or more binders. Binders may help to bind pigment and/or other components of the composition together, and/or may help to bind the composition to a substrate. For example, the binder may help to provide increased adhesion of the pigment(s) to the surface of an edible substrate, wherein the surface may be polished or unpolished. Exemplary binders suitable for the present disclosure include, but are not limited to, binders such as shellac, ethyl cellulose, hydroxypropylmethylcellulose (HPMC), hydroxypropylcellulose (HPC), carboxymethylcellulose (CMC), zein, rosin, rosin esters, xanthan gum, starches (e.g., natural starches and modified starches), dextrins, gum arabic, polyvinyl alcohol (PVA), maltodextrin, and combinations thereof. Such binders may be alcohol soluble or water soluble. In aspects of the present disclosure, the composition may comprise from about 0.1 wt. % to about 35 wt. % such as from about 5 wt. % to about 35 wt. % of one or more binders, based on the total weight of the composition. For example, the composition may comprise from about 0.2 wt. % to about 20 wt. %, such as from about 5 wt % to about 20 wt %, from about 7 wt % to about 15 wt %, or from about 10 wt % to about 20 wt % of one or more binders.

In some examples, the binder of the edible ink composition comprises shellac. The shellac may be esterified or non-esterified shellac. In some aspects of the present disclosure, the shellac may be used in combination with a relatively high molecular weight solvent such as isoamyl alcohol. Combining shellac with isoamyl alcohol (or another alcohol, such as e.g., a relatively high molecular weight alcohol, ethanol, denatured ethanol, isopropyl alcohol, and/or butanol) may help to control viscosity of the composition. For example, the composition may comprise shellac and an alcohol (e.g., ethanol), optionally a denatured alcohol such as denatured ethanol. In some examples, the composition comprises shellac combined with a solvent mixture comprising water, isoamyl alcohol, isopropyl alcohol, and ethanol (e.g., denatured ethanol).

Without being bound by theory, it is believed that ethanol, e.g., denatured ethanol or pure ethanol, optionally with shellac, may allow for relatively higher amounts of pigment (e.g., greater than or equal to 30 wt %), which maintain the desired viscosity. For example, the composition may comprise at least 30 wt. % calcium carbonate (e.g., from about 30 wt. % to about 37 wt. % calcium carbonate), from about 2 wt. % to about 20 wt. % such as from about 5 wt. % to about 20 wt. % shellac (e.g., esterified shellac), and isoamyl alcohol and/or ethanol (e.g., denatured ethanol). In some examples, the shellac and ethanol may be included in the composition in a weight ratio of 1:1.

In some examples, the composition may comprise shellac and at least one other binder such as HPMC, HPC, CMC, and/or zein. Without being bound by theory, it is believed that shellac and HPMC, HPC, CMC, and/or zein may provide the composition with desired film strength and flexibility, and/or may allow for relatively higher amounts of calcium carbonate while maintaining desired viscosity. In some examples, alcohol soluble HPC, HPMC, CMC, and/or zein may be used as an alternative to shellac as a binder. For example, some edible ink compositions herein may comprise up to 5 wt. % or up to 20% wt. % zein as the sole binder or as a binder in combination with HPMC. In some examples, the edible ink composition may comprise at least 0.05 wt. % CMC as a binder in combination with HPMC.

The compositions herein may also include one or more emulsifiers. The emulsifier(s) may help to reduce surface tension and wetting. Further, emulsifiers may also provide for relatively higher amounts of calcium carbonate. Exemplary emulsifiers suitable for the present disclosure include, but are not limited to, lecithin (including, e.g., sunflower lecithin and hydroxylated lecithin), polysorbates (including, e.g., polysorbate 80), sucrose fatty acid esters, polyglycerol esters, monoglyceride esters, and diglyceride esters. In some examples, the composition may comprise a diacetyl tartaric acid ester of mono- and diglycerides (DATEM) an emulsifier. The edible ink compositions herein may comprise from about 0.25 wt. % to about 4 wt. % or from about 2 wt. % to about 4 wt. % emulsifier(s), based on the total weight of the composition. In at least one example, the composition comprises about 4 wt. % of an emulsifier, such as DATEM or hydroxylated lecithin.

An exemplary edible ink composition according to the present disclosure comprises calcium carbonate (e.g., scalenohedral calcium carbonate), shellac and/or zein, ethanol (optionally denatured ethanol), HPMC, and an emulsifier (e.g., polysorbate 80).

In some aspects of the present disclosure, the composition may comprise one or more oil absorbers. Oil absorbers may help to increase oil resistance of the edible ink composition when printed or otherwise transferred to the surface of a substrate (including substrates with waxy coatings). The oil absorber may also help to maintain the color and/or intensity of the ink over time, and resist fading. The oil absorber(s) may promote stability of the edible ink composition on substrates such as polished lentils. Exemplary oil absorbers suitable for the present disclosure include, but are not limited to, native starch (e.g., rice starch), modified starch (e.g., starch sodium octenyl succinate), gum Arabic (acacia gum), sodium caseinate, maltodextrin, cocoa, microcrystalline cellulose, carboxymethylcellulose (CMC), and other cellulosics (e.g., cellulose blends). The compositions herein may comprise greater than 0 to about 4 wt. % oil absorber(s), such as from about 0.2 wt. % to about 4 wt. % oil absorber(s) or from about 2 wt. % to about 4 wt. % oil absorber(s). In at least one example, the composition may comprise about 0.2 wt % CMC. In some examples, the composition may comprise one or more oil deflectors. The one or more oil deflectors may be used either in combination with the one or more oil absorbers or without the one or more oil absorbers. Oil absorbers and/or oil deflectors may also aid in preventing any oil present in the substrate or its coating from penetrating the pigment in the edible ink composition.

One or more additional components may be included in edible ink formulations according to the present disclosure. These additional components may include, but are not limited to, salts, fatty acids, preservatives, natural or artificial flavor compounds, pH modifiers, plasticizers, dispersants, fillers, and micronutrients.

The compositions herein may have a Brookfield viscosity at 25 °C that is less than about or equal to 20,000 cP. In some examples, the compositions herein may have a Brookfield viscosity at 25 °C that is less than about 15,000 cP or less than about 10,000 cP. For example, the viscosity may range from about 30 cP to about 20,000 cP, from about 50 cP to about 15,000 cP, from about 100 cP to about 10,000 cP, from about 250 cP to about 5,000 cP, or from about 500 cP to about 2,000 cP. In some examples, the compositions herein may have a Brookfield viscosity at 25 °C that is less than about 3,000 cP. Such viscosities of the edible ink compositions may be suitable for use, and thus compatible with, manufacturing equipment and printers used for transferring the edible ink composition to the surface of a substrate.

The compositions herein may provide desired properties, for example, visual characteristics, printing quality, binding (e.g., adhesion to a substrate), and/or stability (e.g., durability). Visual properties may include color, opacity, brightness, and/or overall appearance. Stability and durability may be exhibited as a resistance to fading and/or rubbing off a substrate. The compositions herein may provide for a brighter, white color as compared to other edible inks.

According to some aspects of the present disclosure, the composition, e.g., edible ink composition, may be prepared by combining the components in one or more steps. For example, the method may include combining one or more solvents with one or more binders and/or one or more emulsifiers (when emulsifier(s) are used). Optionally, one or more oil absorbers may be added to the mixture. Next, the calcium carbonate (and/or other pigment(s)) may be added. When two or more pigments are used (including two or more different types of calcium carbonate), the pigments may be combined together before addition to the solvent(s), binder(s), emulsifier(s), and oil absorber(s).

In at least one example, preparing the composition includes combining shellac with water and one or more alcohol solvents, such as isoamyl alcohol, isopropyl alcohol, and/or denatured ethanol. The Brookfield viscosity of the resultant composition at 25 °C may be less than or equal to 5000 cP.

The edible ink compositions herein may be applied to the surface of various edible substrates. A suitable application method may include printing as described in greater detail below. The edible substrates may include various food products, such as pet snacks, cereal bars, ice cream products (e.g., ice cream bars) etc., and may also include confectionery products such as candies (hard and soft), mints, chewing gums, gelatins, chocolates, fudge, jellybeans, fondant, licorice, and taffy. The substrate may include a coating, such as a waxy or otherwise hydrophobic coating. For example, the coating may be a yogurt coating.

In some examples herein, the edible ink composition may be applied to the surface of a panned confectionery product. A panned confectionery product may include a center core and at least one coating layer comprising sugar, e.g., crystallized sugar. For example, and not by way of limitation, a panned confectionery product may include a plurality of coating layers. In some examples, the edible core may comprise chocolate. The edible ink composition may be applied to coated chewing gum pellets. In some examples, the surface of the panned confectionery product may comprise a polished coating, and the edible ink composition is applied to the polished coating. The edible ink composition may be printed as a dry film or film that subsequently dries on the polished coating. In some examples, the surface of the panned confectionery product may comprise an unpolished coating, and the edible ink composition is applied to the unpolished coating. The edible ink composition may be printed as a dry film or film that subsequently dries on the unpolished coating. In some examples, a clear or translucent layer may be applied over the edible ink composition.

The panned confectionery product may be a dragée type confectionery product. Non-limiting examples of the type of cores in a dragée type confectionery product may include a natural center (e.g., almond, hazelnut or groundnut) or a “confectionery” center (e.g., caramel, toffee, taffy, fondant or chocolate). The cores may then be coated with chocolate, with successive layers of sugars, or other substances such as polyols, gums and natural polymers that can further include one or more color compositions.

In other aspects of the present disclosure, the edible substrates may include snack food products such as fruit snacks, chips/crisps, extruded snacks, ice cream bars, tortilla/corn chips, popcorn, pretzels, nuts, granola/muesli bars, breakfast bars, energy bars, fruit bars, and other snack bars. In certain aspects, the food product may be a chocolate-coated or yogurt-coated food product.

The edible ink compositions herein also may be applied to the surface of a pharmaceutical product, such as a tablet or capsule (including coated tablets and capsules), or other pharmaceutical product, or a consumer product with a suitable surface for edible ink printing.

When printed or otherwise transferred onto the surface of a substrate, such as an edible product, the edible ink composition may be localized to a particular region of the surface. For example, a shape, logo, lettering, or another localized image may be printed onto the surface of the substrate. Alternatively, the edible ink composition may cover the surface, e.g., providing a solid or patterned appearance across the entire surface.

In some aspects of the present disclosure, the edible ink compositions may be applied to a substrate by a printer. In some examples, the edible ink composition may be applied using a contact printing process, such as an offset rotogravure process. For example, the edible ink composition may be transferred from an etch to a film or roller to the desired surface when contacted with the surface. The contact printing can be facilitated by pressure between the surface to be treated and the film or roller. In other examples, the edible ink compositions may be applied via a different printing process, such as digital printing, screen printing, flexo printing, offset lithography, inkjet printing, or pad printing.

The following examples are intended to illustrate the present disclosure without, however, being limiting in nature. It is understood that the present disclosure encompasses additional embodiments consistent with the foregoing description and following examples.

### EXAMPLES

### Example 1

Various compositions were prepared and evaluated for their suitability in edible ink printing. A base composition was prepared by combining the components shown in Table 1.

TABLE 1

| | Base composition (% wt.) |
|---|---|
| Isoamyl alcohol | 46.5 |
| Water | 27.5 |
| Hydroxypropyl methyl cellulose (HPMC) | 11.6 |
| Isopropyl alcohol | 9.7 |
| Propylene glycol | 4.6 |
| Total | 100.0 |

Compositions A-W were prepared by combining the base composition with various pigments, binders, emulsifiers, and oil absorbers according to Tables 2-24.

TABLE 2

| | Composition A (% wt.) |
|---|---|
| Base composition | 77.5 |
| Scalenohedral calcium carbonate | 22.5 |
| Total | 100.0 |

TABLE 3

| | Composition B (% wt.) |
|---|---|
| Base composition | 44 |
| Scalenohedral calcium carbonate | 36 |
| Esterified shellac solution | 20 |
| Total | 100.00 |

TABLE 4

| | Composition C (% wt.) |
|---|---|
| Base composition | 44 |
| Scalenohedral calcium carbonate | 36 |
| Zein + ethanol solution | 20 |
| Total | 100.0 |

TABLE 5

| | Composition D (% wt.) |
|---|---|
| Base composition | 59 |
| Scalenohedral calcium carbonate | 36 |
| Esterified shellac solution | 5 |
| Total | 100.0 |

TABLE 6

| | Composition E (% wt.) |
|---|---|
| Base composition | 62 |
| Scalenohedral calcium carbonate | 27.2 |
| Cocoa | 6.8 |
| DATEM | 4 |
| Total | 100.0 |

TABLE 7

| | Composition F (% wt.) |
|---|---|
| Base composition | 45 |
| Tricalcium phosphate (TCP) | 35 |
| Esterified shellac solution | 20 |
| Total | 100.0 |

TABLE 8

| | Composition G (% wt.) |
|---|---|
| Base composition | 77 |
| Scalenohedral calcium carbonate | 11.5 |
| Ground limestone (calcium carbonate) | 11.5 |
| Total | 100.0 |

TABLE 9

| | Composition H (% wt.) |
|---|---|
| Base Composition | 46 |
| Scalenohedral Calcium Carbonate | 32 |
| Cocoa | 2 |
| Esterified shellac solution | 20 |
| Total | 100.0 |

TABLE 10

| | Composition I (% wt.) |
|---|---|
| Base composition | 44 |
| Scalenohedral calcium carbonate | 36 |
| Denatured alcohol solution | 20 |
| Total | 100.0 |

TABLE 11

| | Composition J (% wt.) |
|---|---|
| Base composition | 75.5 |
| Scalenohedral calcium carbonate | 22.5 |
| DATEM | 2 |
| Total | 100.0 |

TABLE 12

| | Composition K (% wt.) |
|---|---|
| Base composition | 59 |
| Scalenohedral calcium carbonate | 37 |
| DATEM | 4 |
| Total | 100.0 |

TABLE 13

| | Composition L (% wt.) |
|---|---|
| Base composition | 62 |
| Scalenohedral calcium carbonate | 34 |
| Lecithin | 4 |
| Total | 100.0 |

TABLE 14

| | Composition M (% wt.) |
|---|---|
| Base Composition | 68.5 |
| Scalenohedral calcium carbonate | 31 |
| Polysorbate 80 | 0.5 |
| Total | 100.0 |

TABLE 15

| | Composition N (% wt.) |
|---|---|
| Base composition | 64 |
| Scalenohedral calcium carbonate | 32 |
| Lecithin | 4 |
| Total | 100.0 |

TABLE 16

| | Composition O (% wt.) |
|---|---|
| Base composition | 62 |
| Scalenohedral calcium carbonate | 34 |
| Polysorbate 80 | 4 |
| Total | 100.0 |

TABLE 17

| | Composition P (% wt.) |
|---|---|
| Base composition | 62 |
| Scalenohedral calcium carbonate | 34 |
| Lecithin | 4 |
| Total | 100.0 |

TABLE 18

| | Composition Q (% wt.) |
|---|---|
| Base composition | 64 |
| Scalenohedral calcium carbonate | 32 |
| Lecithin | 4 |
| Total | 100.0 |

TABLE 19

| | Composition R (% wt.) |
|---|---|
| Base composition | 75.5 |
| Scalenohedral calcium carbonate | 22.5 |
| Polysorbate 80 | 2 |
| Total | 100.0 |

TABLE 20

| | Composition S (% wt.) |
|---|---|
| Base composition | 59 |
| Scalenohedral calcium carbonate | 37 |
| Polysorbate 80 | 4 |
| Total | 100.0 |

TABLE 21

| | Composition T (% wt.) |
|---|---|
| Base composition | 70.8 |
| Scalenohedral calcium carbonate | 25 |
| DATEM | 4 |
| Carboxymethylcellulose (CMC) | 0.2 |
| Total | 100.0 |

TABLE 22

| | Composition U (% wt.) |
|---|---|
| Base composition | 69 |
| Scalenohedral calcium carbonate | 25 |
| DATEM | 4 |
| Ethylcellulose | 2 |
| Total | 100.0 |

TABLE 23

| | Composition V (% wt.) |
|---|---|
| Base composition | 77.5 |
| Scalenohedral calcium carbonate | 18.5 |
| Microcrystalline cellulose | 4 |
| Total | 100.0 |

TABLE 24

| | Composition W (% wt.) |
|---|---|
| Base composition | 77.5 |
| Scalenohedral calcium carbonate | 18.5 |
| Gum acacia | 4 |
| Total | 100.0 |

### Example 2

Additional compositions were prepared as follows:

TABLE 25

| | % wt. |
|---|---|
| Esterified shellac solution | 67 |
| Scalenohedral calcium carbonate | 33 |
| Total | 100.0 |

TABLE 26

| | % wt. |
|---|---|
| Denatured alcohol | 67 |
| Scalenohedral calcium carbonate | 33 |
| Total | 100.0 |

TABLE 27

| | % wt. |
|---|---|
| Denatured alcohol | 33.5 |
| Esterified shellac solution | 33.5 |
| Scalenohedral calcium carbonate | 33 |
| Total | 100.0 |

TABLE 28

| | % wt. |
|---|---|
| Scalenohedral calcium carbonate | 31 |
| Esterified shellac solution | 57 |
| Deionized water | 12 |
| Total | 100.0 |

TABLE 29

| | % wt. |
|---|---|
| Scalenohedral calcium carbonate | 28 |
| Esterified shellac solution | 57 |
| Deionized water | 13 |
| Polysorbate 80 | 2 |
| Total | 100.0 |

### Example 3

A base composition was prepared by combining the components shown in Table 30. Compositions X and Y were prepared by combining the base composition with the components according to Tables 31 and 32.

TABLE 30

| | Base composition (% wt.) |
|---|---|
| Isoamyl alcohol | 43.1 |
| Water | 25.4 |
| Hydroxypropylmethyl cellulose (HPMC) | 10.6 |
| Isopropyl alcohol | 16.5 |
| Propylene glycol | 4.3 |
| Total | 100.0 |

TABLE 31

| | Composition X (% wt.) |
|---|---|
| Base composition | 66.8 |
| Scalenohedral calcium carbonate | 28 |
| Ethanol | 4.8 |
| Ethyl acetate | 0.2 |
| Carboxymethylcellulose (CMC) | 0.2 |
| Total | 100.0 |

TABLE 32

| | Composition Y (% wt.) |
|---|---|
| Base composition | 61.8 |
| Scalenohedral calcium carbonate | 28 |
| Ethanol | 4.8 |
| Ethyl acetate | 0.2 |
| Carboxymethylcellulose (CMC) | 0.2 |
| Esterified or shellac solution | 5.0 |
| Total | 100.0 |

The addition of ethanol, scalenohedral calcium carbonate, and CMC in the amounts shown in Table 31 to the base composition to prepare Composition X provided a flowable, printable ink composition.

It should be noted that although various examples are described, the present disclosure is not limited to these examples. Other aspects and embodiments of the present disclosure will be apparent to those skilled in the art from consideration of the specification and practice of the embodiments disclosed herein. It is intended that the specification and examples be considered as exemplary only, with a true scope and spirit of the present disclosure being indicated by the following claims.

1. An edible ink composition comprising:
a pigment comprising at least 26% by weight calcium carbonate, based on a total weight of the composition;
at least one binder; and
at least one solvent;
wherein the composition is edible and formulated for printing on a substrate.

2. The composition of claim 1, wherein the calcium carbonate comprises scalenohedral calcium carbonate.

3. The composition of claim 1, wherein the composition comprises from 27% by weight to about 37% by weight, or from about 30% by weight to about 32% by weight, of the calcium carbonate.

4. The composition of claim 1, wherein the composition comprises from about 5% by weight to about 35% by weight, based on the total weight of the composition, of the at least one binder and/or from about 30% by weight to about 75% by weight, based on the total weight of the composition, of the at least one solvent.

5. The composition of claim 1, wherein the at least one binder comprises shellac, ethyl cellulose, hydroxypropylmethylcellulose (HPMC), hydroxypropylcellulose (HPC), carboxymethylcellulose (CMC), zein, rosin, a rosin ester, xanthan gum or a combination thereof.

6. The composition of claim 1, wherein the at least one binder comprises esterified shellac.

7. The composition of claim 1, wherein the at least one solvent comprises ethanol, optionally denatured ethanol.

8. The composition of claim 1, wherein the composition further comprises at least one emulsifier.

9. The composition of claim 8, wherein the at least one emulsifier comprises lecithin, a polysorbate, a polyglycerol ester, a monoglyceride ester, a diglyceride ester, or a combination thereof.

10. The composition of claim 1, wherein the composition comprises from about 0.25% to about 4% by weight, based on the total weight of the composition, of an emulsifier.

11. The composition of claim 1, wherein the composition further comprises an oil absorber.

12. The composition of claim 11, wherein the oil absorber comprises a natural starch, a modified starch, acacia gum, sodium caseinate, microcrystalline cellulose, maltodextrin, carboxymethylcellulose, cocoa, or a combination thereof.

13. The composition of claim 1, wherein the composition further comprises rice protein, rice starch, tricalcium phosphate, spirulina, cocoa powder, another edible colorant, or a combination thereof.

14. The composition of claim 1, wherein the calcium carbonate comprises scalenohedral calcium carbonate and limestone.

15. The composition of claim 1, wherein at least a portion of the calcium carbonate is encapsulated.

16. The composition of claim 1, wherein the calcium carbonate comprises scalenohedral calcium carbonate and encapsulated calcium carbonate.

17. The composition of claim 1, wherein the composition has a Brookfield viscosity ranging from about 30 cP to less than or equal to 20,000 cP at 25 °C.

18. The composition of claim 1, wherein the at least one solvent comprises an alcohol, water, or a combination thereof.

19. The composition of claim 1, wherein the composition does not comprise isoamyl alcohol.

20. An edible product comprising the composition of claim 1 on a surface of the product, optionally with a clear or translucent layer over the surface.

21. The product of claim 20, wherein the surface is an outermost surface of the product.

22. The product of claim 20, wherein the product is a confectionery product.

23. The product of claim 20, wherein the product is a chewing gum.

24. The product of claim 20, wherein the product comprises a waxy coating, and the composition is printed onto the coating.

25. A method of making the product of claim 21, wherein the method comprises printing the composition on the surface.

26. The method of claim 25, wherein the composition is printed as a logo or lettering on a region of the surface.
